(19) United States
(12) Patent Application Publication
(10) Pub. No.: US 2017/0249697 A1
(43) Pub. Date: Aug. 31, 2017

(54) SYSTEM AND METHOD FOR MACHINE LEARNING BASED LINE ASSIGNMENT

(71) Applicant: American Express Travel Related Services Company, Inc., New York, NY (US)

(72) Inventors: Sanjay S. Agrawal, Basking Ridge, NJ (US); Anand Bhushan, Edison, NJ (US); Anjali Dewan, New York, NY (US); Amber Gupta, Princeton, NJ (US); Vivek Hasija, Jersey City, NJ (US); Biplab Mukherjee, Jersey City, NJ (US); Shalu Wadhwa, Berkeley Heights, NJ (US); Di Xu, Warren, NJ (US); Hao Zhou, Jersey City, NJ (US)

(73) Assignee: American Express Travel Related Services Company, Inc., New York, NY (US)

(21) Appl. No.: 15/055,060

(22) Filed: Feb. 26, 2016

(51) Int. Cl. G06Q 40/02; G06N 7/00

(52) U.S. Cl. CPC G06Q 40/025; G06N 7/005

(57) ABSTRACT

Systems and methods of improving the operation of a transaction network and transaction network devices is disclosed. A line prediction host may comprise various modules and engines, wherein lookalike records may be identified wherein the line assignment of a credit limit to a prospective account holder may be enhanced for enhanced account member value, wherein the transaction network more properly functions according to approved parameters.

### FIELD

The present disclosure relates to data analytics for transaction data.

### BACKGROUND

Large data sets may exist in various sizes and may include various levels of organization. With big data comprising data sets as large as ever, the volume of data collected incident to the increased popularity of online and electronic transactions continues to grow. Billions of rows and hundreds of thousands of columns worth of data may populate a single table. An example of the use of big data is in assigning credit limits (e.g., “line assignment”) to transaction account holders, which is frequently a key factor in transaction account issuer profitability. However, such data is massive in volume and comprises tremendously large data sets. Companies frequently desire to process and analyze this data; however, such processing and analysis is typically time consuming and resource intensive due to the volume of data. These limitations confuse and frustrate line assignment, while also hampering data analytics.

### SUMMARY

A line prediction host may include a test data set creator configured to create a set of test data including a plurality of test datums. Each test datum is representative of a single account holder. Moreover, each test datum includes a first independent variable selected from a first independent variable value set, a first dependent variable of unknown value, and a first personal characteristic set.

In various embodiments, the first independent variable includes a credit line assigned from the first independent variable value set. The first independent variable value set includes one of a continuum of values segregated into tranches, and an array of discrete values including tranches.

In various embodiments, the credit line is randomly assigned. The first dependent variable includes an account member value (“AMV”). The first personal characteristic set includes at least one of a FICO score, an income, a zip code, a debt, an asset, bureau tenure, a risk, a credit capacity, a need for credit, and a credit product held, provided the foregoing list may include further, other, or fewer variables as limited under the various laws, rules, and regulations applicable in various jurisdictions. In various embodiments, the line prediction host further includes a dependent variable evaluator configured to calculate the AMV.

In various embodiments, the line prediction host further includes a test data storer configured to store each calculated AMV in association with each datum within a test data set in a test data storage database. The line prediction host further includes a new datum receiver configured to receive a credit application from a prospective account holder, and assemble a first personal characteristic set of the prospective account holder. The line prediction host further includes a test data set loader configured to access the test data storage database and retrieve the test data set having a first personal characteristic set coincident with the first personal characteristic set of the prospective account holder, wherein only that test data corresponding to real-world account holders similarly situated to the prospective account holder is retrieved. The test data set loader is further configured to pass the test data to a test data/new data comparison engine. The test data/new data comparison engine is configured to receive a retrieved test data set and segregate the test data set into tranches, in response to a value of a line assignment of each datum. The test data/new data comparison engine further determines a highest AMV in at least one of the tranches.

In various embodiments, determining the highest AMV includes measuring a quotient of a change in AMV divided by a change in line assignment, wherein a point of inflection is determined. The test data/new data comparison engine identifies a tranche associated with the point of inflection, wherein the line assignment associated with the highest AMV is identified. The line prediction host further includes a dependent variable assigner configured to receive the line assignment associated with the highest AMV and assign the line assignment to the prospective account holder. The line prediction host further includes a write-off smoother wherein a portion of a write-off associated with a minority of account holders is subtracted from the minority of account holders and assigned across all datums. The quotient of the change in AMV divided by the change in line assignment is smoothed.

A line prediction network may include a line prediction host configured to predict a line assignment, wherein the line prediction host directs data to be stored, a distributed storage system including a plurality of nodes, the distributed storage system configured to direct data to the line prediction host, and a telecommunications transfer channel including a network logically connecting the line prediction host to the distributed storage system.

In various embodiments, the line prediction host includes a processor, a tangible, non-transitory memory configured to communicate with the processor, the tangible, non-transitory memory having instructions stored thereon that, in response to execution by the processor, cause the processor to perform operations, and a test data set creator configured to create a set of test data including a plurality of test datums, wherein each test datum is representative of a single account holder, and wherein each test datum includes a first independent variable selected from a first independent variable value set, a first dependent variable of unknown value, and a first personal characteristic set.

A method of line prediction test data analysis is disclosed. The method may include creating a test data set of test datums, each with a first independent variable with a value selected from a first independent variable value set, and a first dependent variable of unknown value, and a first personal characteristic set shared by all test datums of the test data set, observing a first dependent variable value of each test datum, and storing each test datum and observed first dependent variable value.

In various embodiments, the method of line prediction test data analysis further includes assigning a line assignment to a new datum, wherein the assigning includes receiving the new datum representing a prospective account holder, loading a data set having a first personal characteristic corresponding to that of the new datum wherein groups of the datums having same first dependent variable values are organized into tranches, determining a tranche wherein a change in account member value divided by a change in line assignment is zero and is a maxima, and assigning the line assignment associated the tranche wherein the change in account member value divided by the change in line assignment is zero and is the maxima to the new datum.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 illustrates an exemplary system for distributed storage and distributed processing, in accordance with various embodiments;

FIG. 2 illustrates an exemplary line prediction host component of a system according to FIG. 1, in accordance with various embodiments;

FIG. 3 illustrates an exemplary line prediction test data analysis method of a line prediction host component according to FIG. 2, in accordance with various embodiments;

FIG. 4 illustrates an exemplary line prediction line assignment method of a line prediction host component according to FIG. 2, in accordance with various embodiments;

FIG. 5 depicts a chart showing an example relationship of account member value to line assignment, in accordance with various embodiments.

FIG. 6 illustrates various aspects of write-off smoothing, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

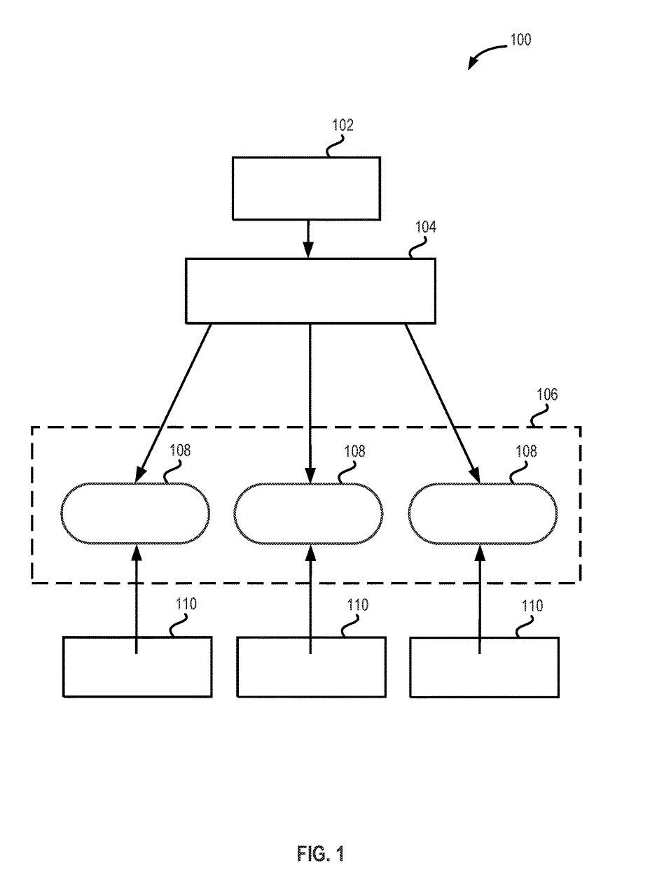

With reference to FIG. 1, system 100 for distributed data storage and processing is shown, in accordance with various embodiments. System 100 may comprise a line prediction host 102. Line prediction host 102 may comprise any device capable of receiving and/or processing an electronic message via telecommunications transfer channel 104. Telecommunications transfer channel 104 may comprise a network. Line prediction host 102 may take the form of a computer or processor, or a set of computers/processors, although other types of computing units or systems may be used, including laptops, notebooks, hand held computers, personal digital assistants, cellular phones, smart phones (e.g., iPhone®, BlackBerry®, Android®, etc.) tablets, wearables (e.g., smart watches and smart glasses), or any other device capable of receiving data over telecommunications transfer channel 104.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptography systems.

In various embodiments, line prediction host 102 may interact with distributed storage system 106 for storage and/or processing of big data sets. As used herein, big data may refer to partially or fully structured, semi-structured, or unstructured data sets including millions of rows and hundreds of thousands of columns. A big data set may be compiled, for example, from a history of purchase transactions over time, from web registrations, from records of charge (ROC), from summaries of charges (SOC), from internal data, transaction network internal data, third party data, credit reporting bureau data, or from other suitable sources. Big data sets may be compiled without descriptive metadata such as column types, counts, percentiles, or other interpretive-aid data points.

In various embodiments, distributed storage system 106 may comprise one or more nodes 108. Nodes 108 may comprise computers or processors the same as or similar to line prediction host 102. Nodes 108 may be distributed geographically in different locations, housed in the same building, and/or housed in the same rack. Nodes 108 may also be configured to function in concert to provide storage space and/or processing power greater than one of a node 108 might provide alone. As a result, distributed storage system 106 may collect and/or store the data 110. Data 110 may be collected by nodes 108 individually and compiled or in concert and collated. Data 110 may further be compiled into a data set and formatted for use.

In various embodiments, data 110 may comprise a collection of data including and/or originating from account holder information, transaction information, account information, record of sales, account history, customer history, sensor data, machine log data, data storage system, public web data, and/or the like. Data 110 may be collected from multiple sources and amalgamated into a big data structure such as a file, for example. In that regard, the data may be used as an input to generate metadata describing the big data structure itself, as well as the data stored in the structure.

The distributed storage system 106 may comprise a transaction network. A line prediction host 102 may comprise various modules and engines as discussed herein wherein data records within data 110 may be evaluated wherein line assignments may be made.

Various systems and methods are provided herein that transform the way credit line is assigned to prospective transaction account holders and current transaction account holders. The mechanisms uniquely leverage various methodologies to optimize profitability and assign the maximum profitable line. The mechanisms precalculate profit, also known as account member value (“AMV”) associated with a line assignment, also known as a credit limit, for an account holder, based on actual behavior of other account holders available from historical data available via a look up file (such as reposed in a test data storage database 211). For instance, AMV may be based on a variety of values such as amount of reward points, amount of spend, amount of interest charged, etc. As such, direct behavioral modeling may replace modeling of behavioral inputs, resulting in more accurate predictions, by virtue of the use of kNN (“known nearest neighbor”) methodology to select a group of identical or substantially identical (“lookalike”) accounts to the application, from the look up file, and then selecting the most profitable line among those lookalikes in order to determine the line associated with the highest AMV for the prospective account holder. Such lookalike accounts may be compared on aspects such as credit score, income, internal data, and/or the like. In various embodiments, various comparisons are done with respect to aspects such as risk (e.g., new accounts risk score), capacity (e.g., income, number of plastic trades, preferred line), need (e.g., revolve ratio, RVBC utilization, external spend or size of wallet, bureau tenure), and/or product (prop-sac indicator).

Thus, mechanisms are provided to optimize profit, identify lookalike accounts, and then precalculate the AMV with effective controls on potential write off balance. Moreover, various historical data may be selected or deselected for use depending on the larger market conditions prevailing at the time of historical data collection and their similarity to the instant prevailing market conditions. As such, the systems and methods are adaptable, meaning that they allow dynamic refreshing of data and/or machine learning.

In brief, training data may be prepared by reviewing historical line assignments, such as may be randomly assigned to extant account holders and for which observed behavior is available, such as profitability, write off rate, and the like. For instance, the write-off balance to initial line ratio, the vintage (e.g., recency) of the data, and the weighting of different personal characteristics of the account holders may be controlled, so that groups of lookalike accounts may be determined.

When a new applicant applies for an account holder transaction account account, a group of lookalike accounts are selected from the training data by a machine learning model that applies the various variables and weights to determine which accounts are lookalike accounts. The lookalike accounts are evaluated for AMV and the credit line associated with the most profitable accounts (e.g., accounts belonging to account holders having the highest AMV) is read. This credit line is assigned to the new account holder.

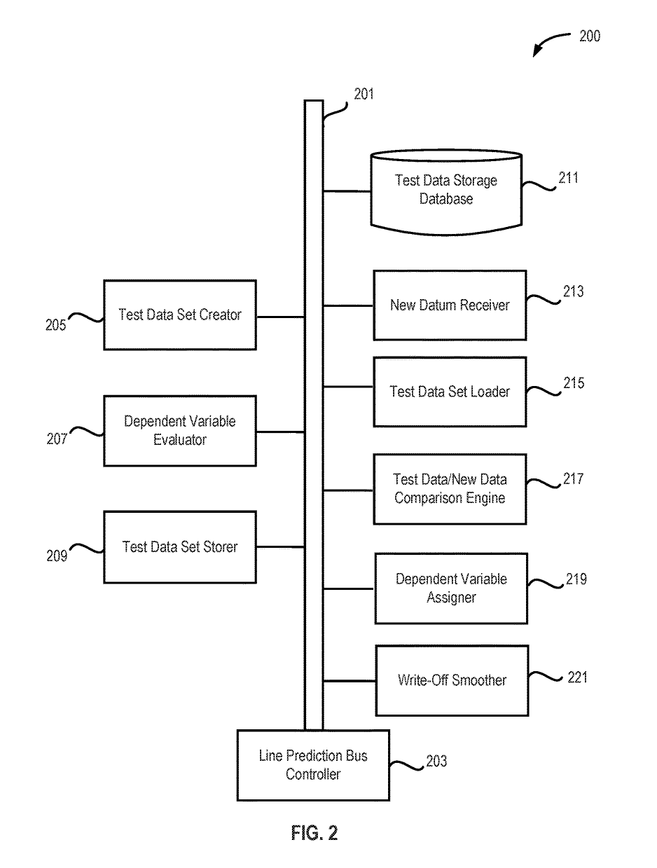

Turning specifically to FIG. 2, a line prediction host 102, may comprise a line prediction control system 200. Line prediction control system 200 may comprise a test data set creator 205. A test data set creator 205 may comprise a module configured to create a set of test data comprising a plurality of test datums. Each test datum may be representative of a single account holder. Each test datum may comprise a first independent variable selected from a first independent variable value set and a first dependent variable of unknown value. Because the datum represents an account holder, the datum may also include a first personal characteristic set. The test data creator may compile a set of test data, wherein each datum shares a same first personal characteristic set.

In various embodiments, the first independent variable may comprise a credit line. The credit line may have a discrete value, for instance $1000 or $5000 or $10000 or any value as desired. A first independent variable value set may comprise an array of discrete values available to be assigned to a first independent variable. In various embodiments, the first independent variable value set comprises a continuum, rather than discrete values, but in such instances, the continuum is segregated into tranches, for instance a first tranche representing credit lines between $500 and $1500, a second tranche representing credit lines between $1500 and $2500, a third tranche representing credit lines between $2500 and $3500, and/or any arrangement of tranches as desired. In various embodiments the value of the first independent variable is assigned randomly.

In various embodiments, the first dependent variable comprises an AMV. The AMV of an account holder may be initially unknown. Because there exists a real-world relationship between the value of the first independent variable and the first dependent variable, and because the value of the first independent variable is randomly assigned, the first dependent variable may then be monitored over time as the account holder uses the account. Because the first dependent variable is the AMV of the account holder, the first dependent variable may be monitored by the transaction account issuer. The value of the first independent variable (e.g., the line assignment) that is associated with the highest AMV may be identified. This line assignment that is associated with the highest AMV may then be assigned to a new account holder as discussed further herein, so that the AMV of those account holders is optimized.

The first personal characteristic set may comprise aspects of an account holder that indicate the real-life financial and lifestyle characteristics of the account holder. For instance, the first personal characteristic set may comprise a FICO score, or an income, or or a zip code, or a debt, or an asset, or any other variable as desired. In various embodiments, various comparisons are done with respect to aspects such as risk (e.g., new accounts risk score), capacity (e.g., income, number of plastic trades, preferred line), need (e.g., revolve ratio, RVBC utilization, external spend or size of wallet, bureau tenure), and/or product (prop-sac indicator). Moreover, the variables comprising the first personal characteristic set may be adaptably determined, for instance by machine learning, so that patterns in available data are determined and new personal characteristics of interest identified. For instance, the variables comprising the first personal characteristic set may be determined with respect to aspects of a first personal characteristic set such as risk, credit capacity, need for credit, and credit product held (e.g., type of transaction account held) by the account holder. For instance, variables such as Q score (or new account risk score) may be a risk variable. Variables such as income, number of transaction accounts held and whether the transaction account at issue is the account holder's preferred account (such as by comparing transaction volume or amount across all accounts held by the account holder), preferred line, etc, may be credit capacity variables. Variables such as revolve ratio, utilization, RVBC utilization, size of wallet, and bureau tenure (length of time as an account holder), may comprise need for credit variables, and variables such as an indicator of what specific account is held by the account holder may be a credit product held variable. Each variable may be assigned a weight depending on machine learning techniques wherein the relative importance of each variable is determined.

The line prediction control system 200 may include dependent variable evaluator 207. A dependent variable evaluator 207 may ingest data 110 and may apply machine learning techniques to the data in order to calculate based on account holder behavior the value of the AMV of the account holder. For instance, the dependent variable evaluator 207 may retrieve the amount of interest earned from the account holder, subtract the amount of reward points paid to the account holder, add the amount of recurring fees charged to the account holder, and/or any other aspect wherein the AMV of the account holder may be determined.

The line prediction control system 200 may also include a test data set storer 209. The test data set storer 209 may store each calculated AMV value with each first independent variable and first personal characteristic set of each datum into a test data storage database 211.

A test data storage database 211 may comprise a database configured to receive the test data set and also to receive calculated AMV values (first dependent variables) of each datum of the test data set and store at least the first dependent variable, first independent variable, and first personal characteristic set of each datum.

Having determined the AMV of each datum in the test data set, the system 200 may also assign a credit line (first independent value) to a new account holder who has a first personal characteristic set shared by account holders of the test data set. The system may determine what credit line amount would cause the account holder to achieve an AMV similar to the highest AMV identified from among account holders from the test data set having identical or substantially identical first personal characteristic set.

For instance, the line prediction control system 200 may comprise a new datum receiver 213. A new datum receiver 213 may receive a credit application from a prospective account holder. The new datum receiver 213 may assemble a first personal characteristic set of the new datum, such as by ingesting internal data, or ingesting third party data, or by querying the prospective account holder, such as via a credit application.

The line prediction control system 200 may also comprise a test data set loader 215. The test data set loader 215 may access the test data storage database 211 and retrieve a test data set having a first personal characteristic set that is coincident with the first personal characteristic set of the prospective account holder. In this manner, only that test data corresponding to real-world account holders who are similarly situated to the prospective account holder are retrieved. This data is passed to a test data/new data comparison engine 217 discussed below.

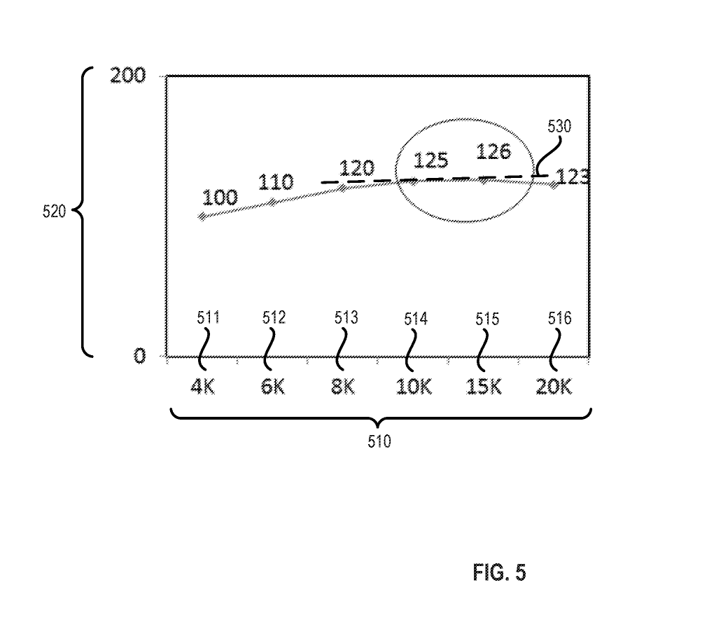

With reference to FIG. 2, and with additional reference to FIG. 5, the test data/new data comparison engine 217 may receive the retrieved test data set having a first personal characteristic set that is coincident with the first personal characteristic set of the prospective account holder. In various embodiments the retrieved test data set may comprise 750 nearest neighbors that are nearest to the new account holder from among a dataset of multiple hundreds of thousands of records. Thus the test data set may comprise these nearest neighbors. The test data/new data comparison engine may segregate the test data set into tranches 511, 512, 513, 514, 515, and 156 based on the value of the line assignment 510 of each datum (e.g., account holder). The test data/new data comparison engine may then review each tranche to determine the highest AMV 520 in that tranche. For instance, it may measure the quotient of change in AMV over change in line assignment, to determine the AMV at which the quotient approaches zero 530. Generally, this will coincide at a point of inflection of AMV/line assignment. The test data/new data comparison engine 217 may then determine which tranche is associated with the highest overall AMV for retrieved test data having a first personal characteristic set. Because the first personal characteristic set of the retrieved test data is coincident with the first personal characteristic set of the prospective account holder, the prospective account holder may then be assigned an identical line assignment to achieve an optimized AMV.

In various embodiments, the dependent variable assigner 219 receives the highest overall AMV for retrieved test data having a first personal characteristic set and makes the line assignment to the prospective account holder.

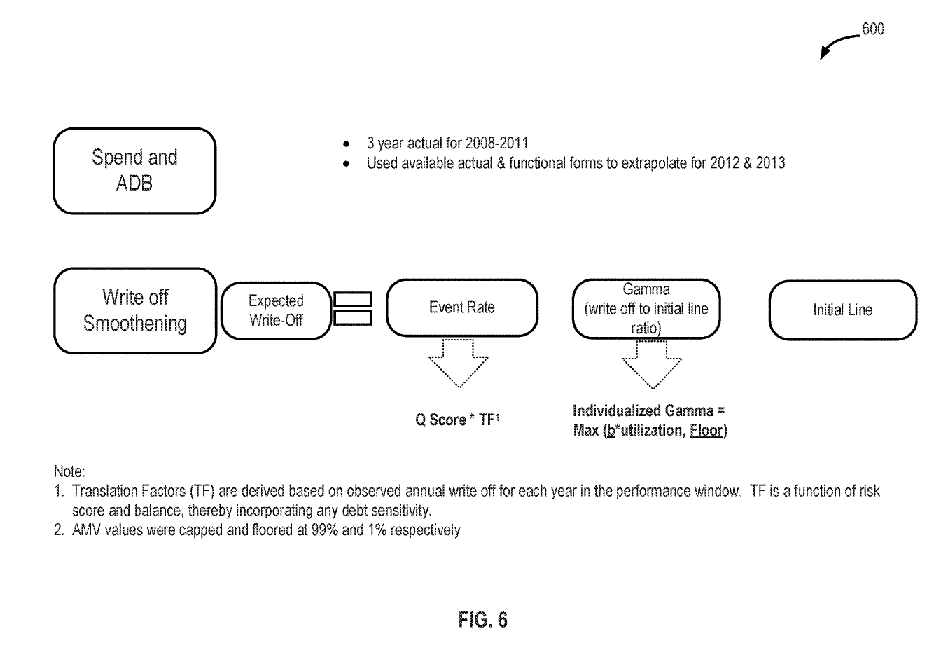

With reference to FIG. 2, and with additional reference to FIG. 6, the line prediction control system 200 may comprise a write-off smoother 221. A write-off smoother 221 may implement a smoothing mechanism 600, wherein the effect of write-offs may be ameliorated prior to the determination of the optimized AMV. A write-off is a balance on a transaction account that the transaction account issuer considers a loss because the account holder is unlikely to pay the balance. Within a retrieved test data set, a minority of account holders will have a write-off while a majority of account holders will not. However, the effect of these write offs on transaction account issuer profitability must be considered when putting the retrieved test data of the test data sets into tranches and then determining what line assignment is associated with an optimized AMV. As such, a portion of the write-off associated with a minority of account holders is subtracted from the responsible account holder and assigned to the other account holders, so that it is evenly spread across all data points (datums) so that the quotient of change in AMV over change in line assignment is accurately determined. For instance, during the creation of test data prior to the selection of nearest neighbors, writeoffs may be smoothened. For instance AMV may be made up of revenue minus costs. Revenue may be determined at least in part based on the actual spend, actual balance, etc., of an actual account holder, however, the costs is associated with the risk of write off. However, whether any one individual will write off an account balance is generally a yes or no proposition, so that the risk of write off is binary. As such, write off smoothing is employed to distribute a portion of this risk among each of the nearest neighbors, in order to more accurately and precisely determine AMV. As such, a fractional risk is assigned through write off smoothing, as discussed.

With renewed reference to FIGS. 1 and 2, each of these aspects of the line prediction host 102 may be in logical communication with a line prediction communication bus 201. As such, each such aspect may interoperate via line prediction communication bus 201 by transceiving messages and data, and may perform various calculations, decisions, and operations in accordance with the teachings herein. Moreover, line prediction host 102 may further comprise a bus controller 203 configured to manage communications among modules on the line prediction communication bus 201, and direct various modules to perform various operations and processes in accordance with methods disclosed herein, as well as direct communications with external components such as distributed storage system 106, nodes 108, and/or the like.

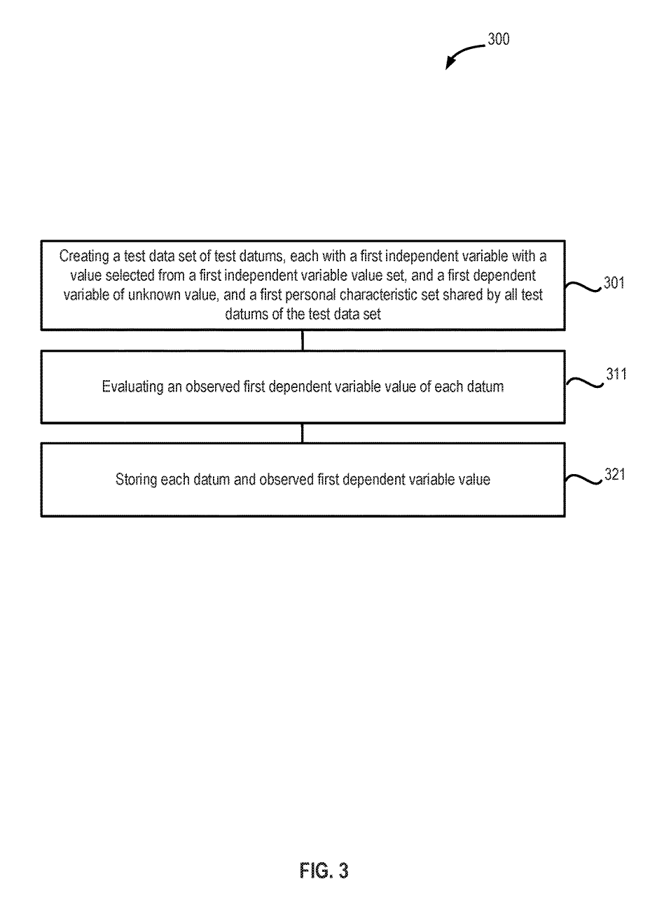

Having discussed various aspects of a line prediction host 102 having a line prediction control system 200, attention is directed to FIGS. 1, 2, 5, and 6, as well as FIG. 3. FIG. 3 provides an exemplary line prediction test data analysis method 300 of the line prediction host 102. For instance, such a method 300 may include creating a test data set of test datums, each with a first independent variable with a value selected from a first independent variable value set, and a first dependent variable of unknown value, and a first personal characteristic set shared by all test datums of the test data set (step 301). Subsequently, the method 300 may further include evaluating an observed first dependent variable value of each datum (step 311). Finally, the method may include storing each datum and observed first dependent variable value (step 321).

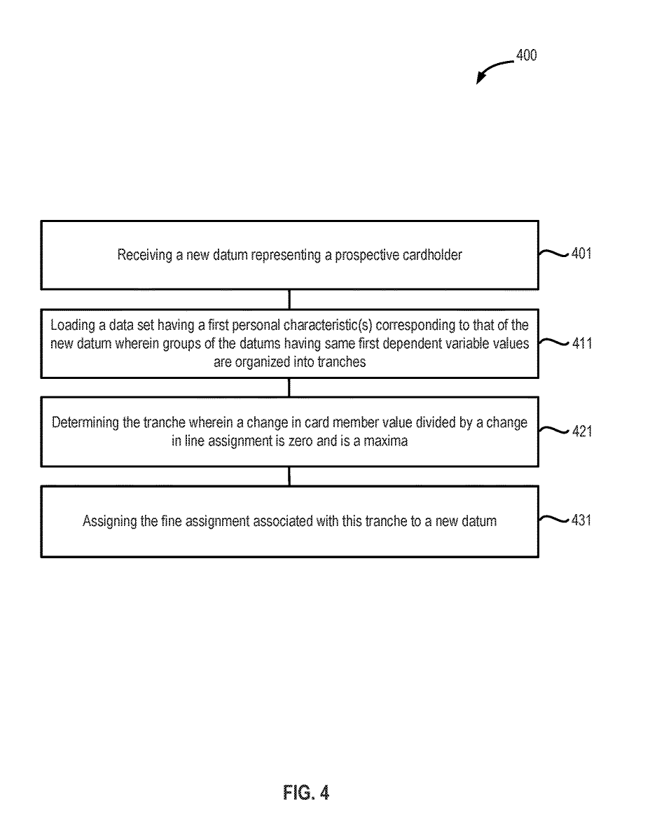

Attention is further directed to FIGS. 1, 2, 5, and 6, as well as FIG. 4. FIG. 4 provides an exemplary line prediction line assignment method 400 of a line prediction host 102 having a line prediction control system 200. Such a method 400 may include receiving a new datum representing a prospective account holder (step 401). The method may further include loading a data set having a first personal characteristic(s) corresponding to that of the new datum wherein groups of the datums having same first dependent variable values are organized into tranches (step 411). The method may further include determining the tranche wherein a change in account member value divided by a change in line assignment is zero and is a maxima (step 421). The method may further include, assigning the line assignment associated with this tranche to a new datum (step 431).

Data, as discussed herein, may include “internal data.” Internal data may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YouTube®, AppleTV®, Pandora®, xBox®, Sony® Playstation®), a uniform resource locator (“URL”), a document (e.g., a Microsoft Word® document, a Microsoft Excel® document, an Adobe .pdf document, etc.), an “ebook,” an “emagazine,” an application or microapplication (as described herein), an SMS or other type of text message, an email, Facebook, twitter, MMS and/or other type of communication technology. In various embodiments, a channel may be hosted or provided by a data partner. In this regard, the channel may be a conduit for data that the system may use to make decisions and/or tailor content. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include Facebook®, foursquare®, Twitter®, MySpace®, LinkedIn®, and the like. Examples of affiliate or partner websites include American Express®, Groupon®, LivingSocial®, and the like. Moreover, examples of mobile device communications include texting, email, and mobile applications for smartphones.

A “consumer profile,” “customer data,” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT®, Windows 95/98/2000®, Windows XP®, Windows Vista®, Windows 7®, OS2, UNIX®, Linux®, Solaris®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, and optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, wherein shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A line prediction host comprising:
a test data set creator configured to create a set of test data,
wherein the set of test data comprises a plurality of test datums,
wherein each test datum is representative of a single account holder, and
wherein each test datum comprises:
a first independent variable selected from a first independent variable value set;
a first dependent variable of unknown value; and
a first personal characteristic set.

2. The line prediction host of claim 1, wherein the first independent variable comprises a credit line assigned from the first independent variable value set.

3. The line prediction host of claim 2, wherein the first independent variable value set comprises one of:
a continuum of values segregated into tranches; and
an array of discrete values comprising tranches.

4. The line prediction host of claim 3, wherein the credit line is randomly assigned.

5. The line prediction host of claim 4, wherein the first dependent variable comprises an account member value (“AMV”).

6. The line prediction host of claim 5, wherein the first personal characteristic set comprises at least one of: a FICO score, an income, a zip code, a debt, an asset, a social media history, a risk, a credit capacity, a need for credit, or a credit product held.

7. The line prediction host of claim 6, wherein the line prediction host further comprises a dependent variable evaluator configured to calculate the AMV.

8. The line prediction host of claim 7, further comprising a test data storer configured to store each calculated AMV in association with each datum within a test data set in a test data storage database.

9. The line prediction host of claim 8, further comprising a new datum receiver configured to receive a credit application from a prospective account holder, and to assemble a first personal characteristic set of the prospective account holder.

10. The line prediction host of claim 9, further comprising:
a test data set loader configured to access the test data storage database and retrieve the test data set having a first personal characteristic set coincident with the first personal characteristic set of the prospective account holder,
wherein only that test data corresponding to real-world account holders similarly situated to the prospective account holder is retrieved, and
wherein the test data set loader is further configured to pass the test data to a test data/new data comparison engine.

11. The line prediction host of claim 10, wherein the test data/new data comparison engine is configured to receive a retrieved test data set and to segregate the test data set into tranches in response to a value of a line assignment of each datum.

12. The line prediction host of claim 11, wherein the test data/new data comparison engine further determines a highest AMV in at least one of the tranches.

13. The line prediction host of claim 12, wherein the determining the highest AMV comprises measuring a quotient of a change in AMV divided by a change in line assignment, wherein a point of inflection is determined.

14. The line prediction host of claim 13, wherein the test data/new data comparison engine identifies a tranche associated with the point of inflection, wherein the line assignment associated with the highest AMV is identified.

15. The line prediction host of claim 14, further comprising a dependent variable assigner configured to receive the line assignment associated with the highest AMV and to assign the line assignment to the prospective account holder.

16. The line prediction host of claim 15, further comprising:
a write-off smoother,
wherein a portion of a write-off associated with a minority of account holders is subtracted from the minority of account holders and assigned across all datums, and
wherein the quotient of the change in AMV divided by the change in line assignment is smoothed.

17. A line prediction network comprising:
a line prediction host configured to predict a line assignment;
wherein the line prediction host directs data to be stored,
a distributed storage system comprising a plurality of nodes,
the distributed storage system configured to direct data to the line prediction host; and
a telecommunications transfer channel comprising a network logically connecting the line prediction host to the distributed storage system.

18. The line prediction network of claim 17, wherein the line prediction host comprises:
a processor,
a tangible, non-transitory memory configured to communicate with the processor,
the tangible, non-transitory memory having instructions stored thereon that, in response to execution by the processor, cause the processor to perform operations; and
a test data set creator configured to create a set of test data,
wherein the set of test data comprises a plurality of test datums,
wherein each test datum is representative of a single account holder, and
wherein each test datum comprises:
a first independent variable selected from a first independent variable value set;
a first dependent variable of unknown value; and
a first personal characteristic set.

19. A method of line prediction test data analysis comprising:
creating a test data set of test datums,
wherein each test datum includes a first independent variable with a value selected from a first independent variable value set, and a first dependent variable of unknown value, and a first personal characteristic set shared by all test datums of the test data set;
observing a first dependent variable value of each test datum; and
storing each test datum and observed first dependent variable value.

20. The method of line prediction test data analysis of claim 19, further comprising:
assigning a line assignment to a new datum,
wherein the assigning comprises:
receiving the new datum representing a prospective account holder;
loading a data set having a first personal characteristic corresponding to that of the new datum wherein groups of the datums having same first dependent variable values are organized into tranches;
determining a tranche wherein a change in account member value divided by a change in line assignment is zero and is a maxima; and
assigning the line assignment associated the tranche,
wherein the change in account member value divided by the change in line assignment is zero and is the maxima to the new datum.
